(19) United States
(12) Patent Application Publication
(10) Pub. No.: US 2026/0356482 A1
(43) Pub. Date: Nov. 12, 2026

(54) ICE PROTECTION MAT, IN PARTICULAR FOR AN AIRCRAFT PART

(71) Applicant: SAFRAN AROSYSTEMS, PLAISIR (FR)

(72) Inventor: Valerie BRIAND, MOISSY-CRAMAYEL (FR)

(73) Assignee: SAFRAN AROSYSTEMS, PLAISIR (FR)

(21) Appl. No.: 19/140,555

(22) PCT Filed: Dec. 22, 2023
(86) PCT No.: PCT/FR2023/052113

§ 371 Date: Jun. 18, 2025

(30) Foreign Application Priority Data
Dec. 23, 2022 (FR) FR 2214394

(51) Int. Cl. B64D 15/16; B32B 5/02; B32B 7/027; B64D 15/12; H05B 3/28

(52) U.S. Cl. CPC B64D 15/16; B32B 5/028; B32B 7/027; B64D 15/12; H05B 3/28; B32B 2262/106; B32B 2307/302; B32B 2605/18; H05B 2214/02

(57) ABSTRACT

An ice protection mat for a part includes one or more heating layers and one or more reinforcing layers. The one or more heating layer incorporates one or more heating resistors. The one or more reinforcing layers is positioned between the one or more heating layers and an external environment, and the one or more reinforcing layers has a thermal conductivity perpendicular to a general plane of extension of the one or more reinforcing layers that is greater than 0.6 W/mK at ambient temperature.

### FIELD OF THE INVENTION

The present invention relates to the protection of aircraft parts against ice. More particularly, it provides an ice protection mat used to protect aircraft parts from ice.

### STATE OF THE ART

An accumulation of ice on an aircraft, particularly in flight, can modify the aerodynamic properties of the aircraft and impair its performance.

Furthermore, if pieces of ice formed or accumulated on an element of the aircraft fuselage or on engine air intakes break off, such pieces can strike portions of the aircraft and damage it.

A build-up of ice can cause at least partial obstruction of the air intakes, which could also cause power losses or even engine shutdown.

This is why aircraft are conventionally equipped with ice protection devices, also called de-icers, installed, for example, on the leading edges of the wings, a rudder, a radome or else on engine air intakes.

Also, on propeller-driven aircraft, the leading edges of the blades or cones are usually equipped with ice protection devices.

Such ice protection devices have the function of removing ice or preventing ice formation. Combined ice protection devices to remove ice and prevent the formation of ice are also known.

There are various technologies for ice protection devices such as pneumatic devices with mechanical effect, hot air circulation de-icers, etc.

The invention relates more particularly to ice protection devices with ice protection mats, in particular thermoelectric mats.

Such an ice protection mat is a heating mat applied to a surface of a part that is to be protected against ice. It provides de-icing or anti-icing by the Joule effect, by circulating a current in a layer incorporating at least one heating resistor. It can be controlled cyclically or be controlled according to an operating mode ensuring permanent heating.

Such a heating mat comprises a heating resistor encapsulated in a matrix of one or more elastomeric materials.

During take-off, landing or in flight, all parts equipped with such a heating mat in contact with the external environment may be subject to impacts, in particular impacts from hailstones, stones, etc., which may cause damage to such parts and seriously damage the heating mat.

Ice protection mat structures in which the elastomer encapsulating the heating resistor is reinforced with a polyamide fabric providing impact protection, are already known.

However, polyamides are poor thermal conductors.

Multi-layer mat structures comprising a heating resistor sandwiched between two Kapton films glued to each other are also known. However, Kapton has poor thermal conductivity.

### DISCLOSURE OF THE INVENTION

One purpose of the invention is to propose a solution allowing to protect an ice protection mat of an aircraft part against impacts, without however degrading the dissipation of the heat flux towards a surface to be de-iced.

Yet another purpose of the invention is to propose a solution allowing to save space and reduce the thickness of such an ice protection mat used to protect aircraft parts from ice. The invention relates to an ice protection mat structure, in particular for an aircraft part, having good temperature homogeneity.

To this end, provision is made of an ice protection mat for at least one part, in particular an aircraft part, comprising at least one heating layer, in particular incorporating at least one heating resistor, and at least one reinforcing layer positioned between the heating layer and an external environment, characterized in that the reinforcing layer has a thermal conductivity perpendicular to a general plane of extension of the reinforcement greater than 0.6 W/mK at ambient temperature.

According to advantageous and non-limiting characteristics, taken alone or in any combination:
the reinforcing layer includes a network of woven, non-woven and/or mesh fibers or threads having a longitudinal thermal conductivity greater than 0.6 W/mK at ambient temperature;
the fibers or threads of the reinforcing layer have a longitudinal thermal conductivity greater than 50 W/mK at ambient temperature;
the fibers or threads of the reinforcing layer have a longitudinal thermal conductivity greater than 120 W/mK at ambient temperature;
the reinforcing layer comprises carbon threads or fibers;
carbon threads or fibers are pitch threads or fibers, in particular coal or petroleum pitch;
the reinforcing layer comprises threads or fibers with a polyacrylonitrile (PAN) type precursor;
the reinforcing layer comprises threads or fibers selected from glass fibers, basalt fibers, silica fibers or metal threads;
the mat comprises an intermediate layer made of an electrically insulating composite material, said composite material comprising:
   a matrix made of an elastomer or polymer, and
   inclusions,
      capable of ensuring the material has a thermal conductivity greater than 0.6 W/mK at ambient temperature, in particular greater than 1.5 W/mK at ambient temperature, the composite material thus allowing better heat dissipation, while ensuring good electrical insulation;
the electrically insulating composite material has an electrical volume resistivity greater than 1E9 Ω·m, preferably greater than 1E10 Ω·m;
the inclusions are ceramic, for example boron nitride, aluminum nitride and/or alumina;
the matrix is selected from polyurethanes, nitriles, neoprenes, silicones, fluorinated silicones and/or epoxides. The matrix can be made of a thermoplastic polymer, in particular a polyetheretherketone “PEEK”, a polyetherketoneketone “PEKK”, a polyetherimide “PEI”, a polysulfone “PSU”, a polyethersulfone “PESU”, a polyphenylsulfone “PPSU”, a polyamide-Imide “PAI” or a polyphthalamide “PPA”;
the volume rate of inclusions is comprised between 10% and 70% by volume, in particular between 20 and 50% by volume, in particular between 30% and 50% by volume.

Provision is also made of an assembly including at least one part, in particular an aircraft part, having an external surface, characterized in that the external surface is covered by an ice protection mat presented previously.

Preferably, a contact layer of the ice protection mat, positioned between the part and the heating layer, is glued or co-vulcanized on the part.

### BRIEF DESCRIPTION OF THE FIGURES

Other characteristics and advantages of the present invention will appear upon reading the following description of a preferred embodiment. This description will be given with reference to the appended figures, including:

FIG. 1 schematically shows an assembly including a part and an ice protection mat according to one embodiment of the invention;

FIG. 2 schematically shows a multilayer structure of the ice protection mat according to one embodiment of the invention;

FIG. 3 schematically shows a composite material of an electrically insulating and thermally conductive layer;

FIG. 4 illustrates a measuring device for determining an electrical resistance of the ice protection mat according to the invention; and

FIG. 5 illustrates a measuring device for determining an electrical resistance and leakage currents of the ice protection mat according to the invention.

### DETAILED DESCRIPTION OF THE INVENTION

In the description which will be given of the invention, the terms “transverse”, “longitudinal” and “radial” qualify a direction of extension of a layer, a fiber and/or a thread.

Thus, the transverse direction corresponds to a direction perpendicular to an extension surface of a layer. It corresponds to a thickness of the layer. In addition, the transverse direction is assimilated to a radial direction of a fiber or a thread of an element constituting a layer. The transverse direction is represented by the axis T in FIG. 2.

Moreover, the longitudinal direction corresponds to a direction of extension of a fiber and/or a thread of an element constituting a layer. The fibers and/or the threads extending along the surface of the element constituting the layer, the longitudinal direction can be according to two components represented by the axis X and the axis Y in FIG. 2.

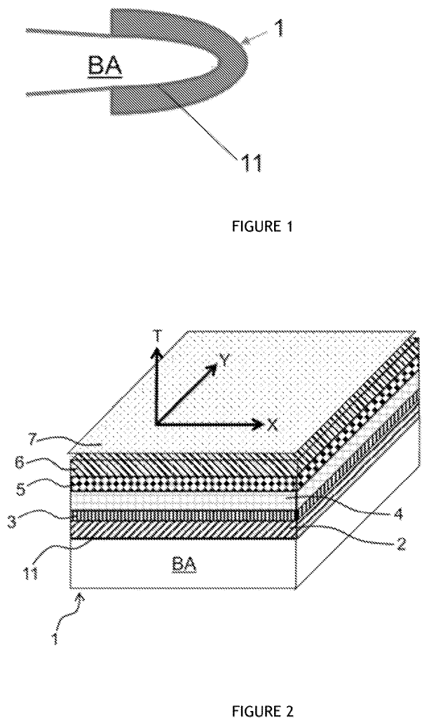

FIG. 1 schematically shows an assembly comprising a part BA, in particular an aircraft part BA, in particular a leading edge of a wing or a propeller of an aircraft, protected from ice by an ice protection mat 1, in particular a thermoelectric mat 1.

The ice protection mat 1 is attached to an outer surface 11 of the part BA to which it conforms, for example by gluing using an adhesive layer not shown.

The ice protection mat 1 comprises a multilayer structure as shown schematically in FIG. 2. The multilayer structure includes in particular a stack of layers, in particular, according to the example shown in FIG. 2, from the part BA, to be protected from ice, towards an external environment:
a contact layer 2, intended to be in contact with the part BA to be protected, in particular the leading edge, and having the function of constituting an electrical barrier and a thermal barrier;
a heating layer 3, intended to be a heat source capable of providing a de-icing and/or anti-icing function, in particular by Joule effect, for the part BA to be protected;
an intermediate layer 4, intended to provide an electrical insulating and thermal conductor function;
a reinforcing layer 5, intended to provide a protection function for the ice protection mat 1, in particular the heating layer 3, against impacts;
an outer layer 6, intended to provide a function of resistance to the external environment, in particular to bad weather and temperature conditions likely to be encountered by the aircraft.

The stacking of the different layers is of a low thickness, typically less than 2 mm, in particular less than 1.5 mm, advantageously less than 1 mm.

If necessary, the multilayer structure may be covered with a layer of paint 7.

In particular, the ice protection mat 1 comprising the multilayer structure may have an electrical insulation resistance of at least 10 MΩ, in particular at least 100 MΩ.

According to the exemplary embodiment shown in FIG. 2, the contact layer 2 is arranged in the multilayer structure so as to be positioned between an outer surface 11 of the part BA to be protected from ice and the heating layer 3.

The contact layer 2 is designed so as to be in contact with the part BA to be protected, in particular the leading edge, and its function is to constitute an electrical barrier and a thermal barrier.

In particular, the contact layer 2 can be made of a material having electrical and thermal insulation properties.

The contact layer 2 thus allows to avoid excessively high contact temperatures with the part BA to be protected against ice.

The material of the contact layer 2 may be an elastomer, a polymer, in particular a thermoplastic polymer or a thermosetting polymer, in particular an epoxy resin.

Alternatively, the contact layer 2 may be made of an insulating foam.

According to a particular embodiment, the contact layer 2 may also be made of an insulating honeycomb structure. Alternatively or additionally, the contact layer 2 may also be made of a mixture of elastomer or polymer filled with glass beads, in particular hollow glass beads.

Thus configured, the contact layer 2 protects the part BA on which the ice protection mat 1 is mounted from possible overheating. Indeed, due to the thermal insulation properties of the contact layer 2, the heat released by the heating layer 3 is directed towards an outer surface of the ice protection mat 1 on which ice is likely to form, arranged, according to the multilayer structure, opposite the contact layer 2 and therefore the part BA to be protected against ice.

Furthermore, it is desirable to avoid any circulation of an electric current between the heating layer 3 and the part BA.

In particular, the contact layer 2 may have a volume resistivity of at least 1E9 Ω·m, preferably greater than 1E10 Ω·m.

A thermal conductivity of the contact layer 2, considered perpendicular to a general plane of extension of the contact layer 2, also called transverse thermal conductivity, is less than 0.4 W/mK at ambient temperature. Ambient temperature means, throughout the present description, a temperature of the order of 20 °C.

The contact layer 2 may have a thickness of less than 1.5 mm, in particular less than 1 mm, advantageously less than 0.7 mm. Moreover, the contact layer 2 may have a thickness greater than 0.2 mm, in particular greater than 0.3 mm, advantageously greater than 0.6 mm.

According to the exemplary embodiment presented in FIG. 2, the heating layer 3 is arranged in the multilayer structure so as to be positioned between the contact layer 2 and the intermediate layer 4.

The heating layer 3 is designed to provide a heat source capable of ensuring a de-icing and/or anti-icing function by Joule effect for the part BA to be protected.

In particular, the heating layer 3 may be a resistive layer for Joule heating.

However, the heating layer 3 can be produced from any heating means capable of generating a heat flux, such as in particular, but without limitation, metal tracks, heating threads, conductive inks, fabrics or non-wovens using fibers, etc.

For example, the heating layer 3 can integrate a mesh of metal tracks intended to be traversed by a current to generate the heat flux by Joule effect.

The metal tracks can be very close to each other to cover the surface as homogeneously as possible. As will nevertheless be understood more particularly through the following description, the longitudinal thermal conduction ensured by fibers and/or threads of the reinforcement allows a spacing of the metal tracks greater than that currently possible according to the state of the art.

In particular, the metal tracks cover at least 50% of the surface of the heating layer 3, in particular at least 70% of the surface of the heating layer 3.

Power supply electrical connections allow connection to a power source to energize the metal tracks.

Typically, the heating layer 3 releases a heating power comprised between 1 and 5 W/cm², in particular between 2 and 5 W/cm², depending on whether it operates in cyclic mode or in continuous mode.

The heating layer 3 may have a thickness of less than 0.3 mm, in particular less than 0.25 mm, advantageously less than 0.15 mm. Furthermore, the heating layer 3 may have a thickness greater than 0.015 mm, in particular greater than 0.05 mm. Typically, the heating layer 3 may have a thickness of the order of 0.15 mm.

According to the exemplary embodiment presented in FIG. 2, the intermediate layer 4 is arranged in the multilayer structure so as to be positioned between the heating layer 3 and the reinforcing layer 5.

The intermediate layer 4 is designed to provide an electrical insulating and thermal conductor function.

In particular, the intermediate layer 4 can be made of a composite material selected to have good electrical insulation and good thermal conduction properties.

The intermediate layer 4 helps to direct the heat flux generated by the heating layer 3 towards the outer surface of the ice protection mat 1, that is to say opposite the contact layer 2 and therefore the part BA to be protected against ice.

In particular, the intermediate layer 4 may have a volume resistivity of at least 1E9 Ω·m, preferably greater than 1E10 Ω·m.

A thermal conductivity of the intermediate layer 4, considered perpendicular to a general plane of extension of the intermediate layer 4, also called transverse thermal conductivity, is greater than 0.4 W/mK at ambient temperature, in particular greater than 0.6 W/mK at ambient temperature, in particular greater than 0.8 W/mK at ambient temperature, specifically greater than 1.5 W/mK at ambient temperature, determined according to the methods described in standards ISO 8302 or ASTM C177.

The intermediate layer 4 may have a thickness of less than 1.5 mm, in particular less than 1 mm, advantageously less than 0.7 mm. Moreover, the intermediate layer 4 may have a thickness greater than 0.2 mm, in particular greater than 0.3 mm. Typically, the intermediate layer 4 may have a thickness of the order of 0.4 mm.

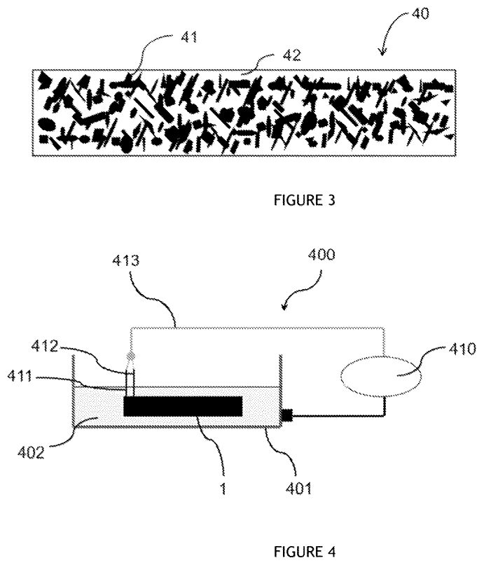

As more particularly illustrated in FIG. 3, the intermediate layer 4 can be made from a composite material 40 comprising a matrix 42 and inclusions 41.

According to the exemplary embodiment presented in FIG. 2, the reinforcing layer 5 is arranged in the multilayer structure so as to be positioned between the heating layer 3 and the outer layer 6.

The reinforcement layer 5 is designed to provide a function of protecting the ice protection mat 1, in particular the heating layer 3, from impacts, such as gravel, hailstones, blows related to maintenance, etc.

In particular, the reinforcing layer 5 can be made of a material allowing circulation of the heat flux generated by the heating layer 3, towards the outer surface of the ice protection mat 1, that is to say opposite the contact layer 2 and therefore the part BA to be protected against ice.

In particular, the reinforcing layer 5 may be presented, for example, in the form of a woven, non-woven, such as felt, or mesh reinforcement extending along a general plane of extension of the reinforcing layer 5.

A thermal conductivity of the reinforcing layer 5, considered perpendicular to the general plane of extension of the reinforcing layer 5, also called transverse thermal conductivity, greater than 0.4 W/m. K at ambient temperature, in particular greater than 0.6 W/m. K at ambient temperature, in particular greater than 0.8 W/m. K at ambient temperature, specifically greater than 1.5 W/mK at ambient temperature, determined according to the methods described in standards ISO 8302 or ASTM C177.

More specifically, the reinforcing layer 5 may include fibers and/or threads. In such a configuration, the fibers and/or threads of the reinforcing layer may further have a longitudinal thermal conductivity greater than 0.6 W/mK at ambient temperature.

Longitudinal thermal conductivity is a thermal conductivity considered in a direction parallel to a direction of extension of the fibers and/or threads. Consequently, the longitudinal thermal conductivity of the fibers and/or threads corresponds to the thermal conductivity along the general plane of extension of the reinforcing layer 5.

The longitudinal thermal conductivity at ambient temperature greater than 10 W/mK allows longitudinal homogenization of the temperature of the reinforcement layer 5, that is to say in the general plane of extension of the reinforcement layer 5.

Alternatively, to ensure homogeneity, the longitudinal thermal conductivity may be greater than 50 W/m K, particularly along the fiber axis.

Advantageously, a radial conductivity of the fibers corresponds to the transverse conductivity of the ice protection mat 1. It must therefore logically be equivalent to that of the intermediate layer 4 and of an outer layer 6, described below.

Such thermal conductivity is particularly important when the heating layer 3 is constituted by a network of metal tracks not having a homogeneous heating surface. Indeed, in such a case, the heat flux emitted by the metal tracks of the heating layer 3 is longitudinally heterogeneous. The homogenization of the heat flux in the general plane of extension of the reinforcement layer 5 allows greater de-icing or anti-icing efficiency, since the diffusion of the heat flux generated by the heating layer 3 in order to ensure the de-icing and/or anti-icing function is diffused over the entire surface of the ice protection mat 1 without heterogeneity.

It will further be noted that the homogenization function that the reinforcing layer 5 provides, in particular in the form of a fabric, a non-woven fabric, a knit, a mesh and/or a unidirectional reinforcement, a combination and/or a stack thereof, allows to relax constraints on the spacing of the tracks of the heating layer 3. It is thus possible to use heating metal tracks that are further apart from each other compared to what is currently possible in the known solutions of the state of the art.

Consequently, the invention thus offers the possibility of using technologies for manufacturing the heating layer 3, in particular the heating resistors, in particular by additive manufacturing. Preferably, the reinforcing layer 5 incorporates a network of woven, non-woven, knitted, meshed fibers and/or threads, and/or a unidirectional reinforcement, in particular carbon fibers manufactured from a pitch fiber precursor, in particular coal or petroleum pitch, and/or threads having a longitudinal thermal conductivity at ambient temperature greater than 50 W/mK.

More preferably, the woven or mesh reinforcement of the reinforcement layer 5 incorporates fibers having a longitudinal thermal conductivity at ambient temperature greater than 120 W/mK.

The fibers and/or threads of the reinforcing layer 5 may be of different types such as, for example, glass fibers, basalt fibers, silica fibers, metal threads, etc.

Preferably, the reinforcing layer 5, in particular in the form of a woven, non-woven or mesh reinforcement, is made of carbon fibers, which have the advantage of having good thermal conductivity properties.

More preferably, the carbon fibers of the reinforcing layer 5 are manufactured from coal or petroleum pitch. Such a production of the carbon fibers allows a radial thermal conductivity greater than 0.6 W/mK, in particular greater than 10 W/mK, and/or a longitudinal thermal conductivity greater than 50 W/mK, in particular greater than 120 W/mK.

According to another embodiment, the fibers of the reinforcing layer 5 comprise carbon fibers with a polyacrylonitrile (PAN) type precursor. Such an embodiment has a radial thermal conductivity greater than 1 W/m. K and a longitudinal thermal conductivity greater than 10 W/m·K.

It will further be noted that the reinforcing layer 5 can also participate in the protection function participate in the protection function against electrostatic discharges, also referred to by the acronym “ESD”.

For example, in the case where the reinforcing layer 5 is made of carbon fabric and/or contains metal, the reinforcing layer 5 can be used for grounding intended to ensure the evacuation of electrostatic charges.

In such a hypothesis, the reinforcing layer 5 can contribute, at least in part, to protection against lightning.

The reinforcement layer 5 may have a thickness of less than 1.5 mm, in particular less than 1 mm, in particular less than 0.7 mm, advantageously less than 0.3 mm. Furthermore, the reinforcing layer 5 may have a thickness greater than 0.02 mm, in particular greater than 0.05 mm. Typically, the reinforcing layer 5 may have a thickness of the order of 0.1 mm.

According to the exemplary embodiment presented in FIG. 2, the outer layer 6 is arranged in the multilayer structure so as to be positioned between the reinforcing layer 5 and the paint layer 7.

Alternatively, the outer layer 6 is arranged in the multilayer structure so as to be disposed on the reinforcing layer 5 and in direct contact with the external environment.

The outer layer 6 is designed to provide a function of resistance to the external environment, in particular to bad weather, temperature conditions, and fluid projections likely to be encountered by the aircraft.

In particular, the outer layer 6 may be made of an elastomer or polymer resistant to the external environment, in particular to bad weather and temperature conditions likely to be encountered by the aircraft.

In particular, the outer layer 6 resists erosion under the conditions defined by the standard Sand & Dust RTCA-DO-160.

In addition, the outer layer 6 contributes to shock protection.

In addition, the outer layer 6 may also be of a composition including fillers enabling it to dissipate electrostatic charges.

Additionally, the outer layer 6 is thermally conductive and does not necessarily have electrically insulating properties.

The outer layer 6 may have a thickness of less than 1.5 mm, in particular less than 1 mm, advantageously less than 0.5 mm. Moreover, the outer layer 6 may have a thickness greater than 0.1 mm, in particular greater than 0.2 mm. Typically, the outer layer 6 may have a thickness of the order of 0.2 mm.

According to the exemplary embodiment presented in FIG. 2, the paint layer 7 can be applied to the multilayer structure so as to cover the multilayer structure.

In particular, the paint layer 7 is designed to have properties of resistance to the external environment and/or resistance to erosion, in particular under the conditions of the standard Sand & Dust RTCA-DO-160.

In addition, the paint layer 7 may also be of a composition including fillers enabling it to dissipate electrostatic charges.

Additionally, an application of the paint layer 7 on the multilayer structure may require a prior application of an adhesion primer on the multilayer structure, in particular on the reinforcement layer 5, or of an adhesion treatment by dry process, for example by plasma.

Thus arranged and according to the invention, the ice protection mat 1 has a total thickness of less than 1.9 mm, in particular less than 1.5 mm, in particular less than 1 mm.

As previously specified, the intermediate layer 4 can be made from a composite material 40 comprising a matrix 42 and inclusions 41.

The matrix 42 is made of an electrically insulating elastomer. Such an elastomer is selected to have good resistance in a range of typical temperatures of use of the ice protection mat 1.

The maximum operating temperature of the ice protection mat 1 is a temperature that can be reached by the heating layer 3 during generation of the heat flux necessary for a de-icing cycle. Because the intermediate layer 4 is in direct contact with the heating layer 3, one face of the intermediate layer 4 in contact with the heating layer 3 must withstand the maximum operating temperature.

Because the heating layer 3 is covered by the intermediate layer 4, there is further an effect of accumulation of the heat flux at an interface between the heating layer 3 and the intermediate layer 4. The maximum temperature can typically be comprised between 100 °C and 110 °C.

Preferably, the matrix 42 is made of a thermosetting polymer, in particular an elastomeric material or an epoxy resin.

It is nevertheless possible that the matrix 42 is made of another type of polymer, such as, for example, a thermoplastic polymer.

To obtain good resistance and guarantee suitable mechanical properties in the operating temperature range between the minimum temperature and the maximum temperature, it is particularly advantageous for the matrix 42 to be made of a polymer selected from polyurethanes, nitriles, neoprenes, silicones, fluorinated silicones and/or epoxides.

In particular, the matrix 42 may be made of a thermoplastic polymer, such as a polyetheretherketone, also designated by the acronym PEEK, a polyetherketoneketone, also designated by the acronym PEKK, a polyetherimide, also designated by the acronym PEI, a polysulfone, also designated by the acronym PSU, a polyethersulfone, also designated by the acronym PESU, a polyphenylsulfone, also designated by the acronym PPSU, a polyamide-Imide, also designated by the acronym PAI, or a polyphthalamide, also designated by the acronym PPA.

Such materials have the advantage in particular of withstanding a contact temperature with the heating layer 3, capable of generating the heat flux, of the order of 100 °C continuously, particularly favorable for ensuring the de-icing and/or anti-icing function.

Advantageously, the material of the matrix 42 is adapted to be shaped by a vulcanization method after incorporation of the inclusions 41. Such a method allows the position of the inclusions 41 to be fixed.

Another advantage of such vulcanization shaping is the possibility of carrying out co-vulcanization with another material of an adjacent layer, for example the heating layer 3 with which close contact is required.

In the embodiment in which the heating layer 3 is made from metal tracks or heating threads, the latter are advantageously coated with a primer capable of ensuring a connection with the matrix 42.

Moreover, it is entirely possible to have different connection modes between the different layers of the multilayer structure of the ice protection mat 1, such as, for example, bonding, co-vulcanization or, more generally, co-firing.

The matrix 42 includes inclusions 41. In particular, the inclusions 41 are made of a material having a high electrical volume resistivity, in particular greater than 1E9 Ω·m, preferably greater than 1E10 Ω·m.

Such electrical resistivity of the inclusions 41 allows to obtain a material whose overall electrical resistivity corresponds to the electrical insulation requirements of the intermediate layer 4 arranged in direct contact with the heating layer 3.

Moreover, inclusions 41 have a thermal conductivity greater than 1.5 W/mK at ambient temperature, in particular above 20 W/m K.

Such thermal conductivity of the inclusions 41 allows to increase the thermal conductivity of the intermediate layer 4. Such a configuration thus allows better transmission of the heat flux generated by the heating layer 3 towards the surface to be de-iced.

By increasing the heat flux transmission, it is possible to achieve energy savings necessary to ensure the de-icing and/or anti-icing function for the part BA to be protected.

Moreover, good thermal conductivity of the intermediate layer 4 allows to reduce an accumulation effect of the heat flux at the heating layer 3. It is thus possible to lower the temperature to which the intermediate layer 4 is exposed near the contact area with the heating layer 3. Such a reduction in temperature in such a contact area prevents, to a certain degree, the degradation of the material of the matrix 42.

The improved thermal conductivity thus allows to increase the service life of the heating layer 3 and/or to use other materials for producing the matrix 42 which have less resistance to high temperatures, provided that the surface temperature of the part BA to be protected remains within a reasonable range.

Advantageously, the material of the inclusions 41 is a ceramic having good thermal conductivity and electrical insulation properties.

Preferably, the inclusions 41 are made of boron nitride, aluminum nitride, alumina or a coupling of such fillers.

Other ceramics with different electrical resistivity and thermal conductivity parameters can be used.

According to a particular embodiment, the inclusions 41 have a volume rate in the matrix 42 typically comprised between 10% and 70% by volume, in particular comprised between 20 and 50% by volume, in particular comprised between 30% and 50% by volume.

Such a volume ratio allows to maintain the mechanical properties of the matrix 42 for shaping and use of the intermediate layer 4 while allowing to use the thermal properties of the inclusions 41 to improve the thermal conductivity of the material as a whole.

An example of the manufacture of a composite material capable of constituting the intermediate layer 4 will now be described.

A first step consists of providing a base material for a formulation of the matrix polymer 42. Such a base material is typically provided in the form of plates, petals or granules and does not include any solvent. For example, the starting material may be rubber.

In a second step, the base material is mixed, for example in a closed mixer with several propellers or a cylinder mixer, also called an open mixer.

The elements of the base material are heated by a shear effect occurring during mixing.

During the second step, the base material transforms into a homogeneous viscous material.

In a third step, particles intended to form inclusions 41 are added. Such particles are provided in the form of powders and can be agglomerated during their production or storage.

The particles are added during the third step consisting of a mixing step. The third step allows to separate any agglomerates and to distribute the particles homogeneously in the viscous material intended to form the matrix 42, in particular made of polymer.

When the inclusions 41 are distributed in the matrix 42, during a fourth step, the intermediate layer 4, the thickness of which can be comprised between 0.2 mm and 0.7 mm, typically a thickness of the order of 0.4 mm, is formed.

The formation of the intermediate layer 4 can be carried out by calendering, by extrusion, in particular by extrusion of film in a flat die.

Subsequently, during a fifth step, the matrix 42 is shaped using dedicated tool then vulcanization is carried out in order to hold the inclusions 41 in place and to fix a geometry of the intermediate layer 4.

In some embodiments, it is possible to form the intermediate layer 4 directly in contact with the heating layer 3. In such cases, co-vulcanization is carried out between the polymer matrix 42 and the heating layer 3. Such co-vulcanization allows to ensure good mechanical and thermal contact between the intermediate layer 4 and the heating layer 3.

To test the intermediate layer 4 and more generally the structure of the ice protection mat 1, a test device 400 as illustrated in FIG. 4 is used.

Advantageously, the ice protection mat 1, comprising the contact layer 2, the heating layer 3, the intermediate layer 4, the reinforcing layer 5, and the outer layer 6, is tested.

The test device 400 comprises an electrically conductive reservoir 401, typically a metal reservoir, filled with an amount of water 402.

A stack comprising at least the contact layer 2, the intermediate layer 4, which is in particular electrically insulating made of composite material 40, and the heating layer 3 is immersed in the amount of water 402.

Alternatively, the ice protection mat 1, comprising the contact layer 2, the heating layer 3, the intermediate layer 4, the reinforcement layer 5, and the outer layer 6, is immersed in the amount of water 402.

As a result, two electrodes 411, 412 are connected to the heating layer 3 via the power supply threads and establish an electrical connection 413 with a resistance measuring device 410, such as an ohmmeter. The resistance measuring device 410 is electrically connected to the tank 401.

An electrical voltage, in particular an electrical voltage of 500 V DC, is then applied between the reservoir 401 and the electrodes 411, 412 connected to the heating layer 3.

Preferably, the voltage applied during the test is twice as high as an operating voltage of the de-icing and/or anti-icing device for the part BA to be protected from ice, which can be 220 V to 230 V.

Alternatively, the operating voltage of the de-icing and/or anti-icing device for the part BA to be protected from ice can be supplied at 110 V.

As a result, a first test step consists of a measurement of an insulation resistance measured by the resistance measuring device 410.

A result of the first test step is considered validated if the following conditions are met:
The stack including the heating layer 3 is intact, namely that no damage due to an electric arc is visible between the heating layer 3 and the surface of the contact layer 2 and/or between the heating layer 3 and the surface of the outer layer 6; and
An insulation resistance measured by the resistance measuring device 410 is greater than 10 MΩ, in particular greater than 100 MΩ.

The value of the measured insulation resistance can be adjusted according to the specifications of the intended application.

Additionally, in order to confirm the reliability of the material, several repetitions of the test can be carried out successively.

Subsequently, a second test step consists of a verification of dielectric resistivity and leakage currents.

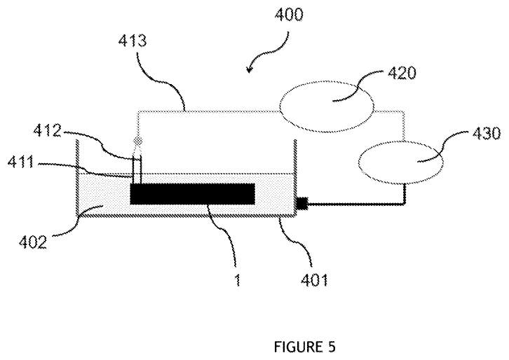

The test device 400 for the second test step is illustrated in FIG. 5. Elements common to the test device of FIG. 4 are indicated by the same references and will not be described again. The test device 400 includes a leakage current measuring device 420, for example in the form of an ammeter, in electrical connection with the electrodes 411 and 412 connected to the intermediate layer 4.

In addition, the test device 400 includes a voltage source 430 in electrical connection with the leakage current measuring device 420 and the reservoir 401. By way of example, the voltage source 430 provides an electrical voltage of at least 1500 V in alternating current with a frequency comprised between 50 Hz and 60 Hz.

In the second test step, the electrical voltage is applied. For this purpose, the electrical voltage is gradually increased between 0 V and twice the operating voltage of the de-icing and/or anti-icing device increased by 1000 V for 20 seconds. The resulting electrical voltage is then maintained for one minute.

A result of the second test step is considered validated if the following conditions are met:
The stack including the heating layer 3 and the intermediate layer 4 is intact, namely that no damage due to an electric arc between the components of the test device 400 and/or between the heating layer 3 and the intermediate layer 4 is visible;
The stack including the heating layer 3 is intact, namely that no damage due to an electric arc is visible between the heating layer 3 and the surface of the contact layer 2 and/or between the heating layer 3 and the surface of the outer layer 6; and
A leakage current measured by the leakage current measuring device 420 is less than 200 mA, in particular less than 50 mA, in particular less than 30 mA.

The leakage current value measured by the leakage current measuring device 420 can be adjusted according to the specifications of the intended application.

The intermediate layer 4 can be integrated into any stack of functional layers, requiring both electrical insulation and thermal conduction.

In the case of the thermoelectric ice protection mat 1 of FIG. 1, the intermediate layer 4 arranged on the heating layer 3 improves the de-icing performance and allows to reduce the heating temperature of the heating layer 3.

Reducing the temperature of the heating layer 3 has an advantage for the integration of the ice protection mat 1 on temperature-sensitive parts, and in particular composite parts.

Moreover, the matrix 41 is advantageously made of an elastomer, thus allowing to adapt the intermediate layer 4 and the ice protection mat 1 to complex part shapes, in particular to three-dimensional parts, in particular non-developable three-dimensional parts.

The shaping is done with the unvulcanized elastomer, the intermediate layer 4 then being fixed by vulcanization. After vulcanization, however, it is possible to maintain elasticity for the intermediate layer 4.

Other applications than those of thermoelectric ice protection mats 1 are of course possible for the material just described, such as, for example, heat sinks).

Different techniques are possible for assembling the different layers of the ice protection mat 1, according to the invention.

In one possible embodiment, the contact layer 2, which constitutes a thermal and electrical barrier, can be directly formed on the heating layer 3, in particular by projection.

Alternatively or in addition, the contact layer 2 includes elastomer sheets which are superimposed manually or with automatic draping. The material of the contact layer 2 may be an elastomer, a polymer, in particular a thermoplastic polymer or a thermosetting polymer, in particular an epoxy resin.

Similarly, the intermediate layer 4, which provides an electrical insulating and thermal conductor function and has a greater thermal conductivity than the contact layer 2 to direct the dissipation of the heat flux towards the external environment.

The reinforcing layer 5 can then be assembled to the intermediate layer 4 and the outer layer 6, for example by gluing.

The outer layer 6 can be formed directly on the reinforcing layer 5, in particular by projection. In another possible embodiment, the various layers of the multilayer structure are superimposed on each other, manually or by automatic draping, then assembled together by various assembly methods.

For the various bonding operations, the surfaces to be bonded can be prepared by any adhesion treatment, in particular by dry process or by plasma.

A method for manufacturing the ice protection mat 1 may include at least the following steps taken separately or in combination:
The contact layer 2, the intermediate layer 4 and/or the outer layer 6 are calendered from elastomer mixtures, advantageously used in a raw form during all steps of the manufacturing method;
The heating layer 3 is preferably a heating resistor obtained by chemical cutting of a metal strip, a value of the heating resistance of the ice protection mat 1 being controlled during this step;
The heating layer 3 is covered with at least one primer to allow a bond with the elastomers during the vulcanization step, the heating layer 3 being able to be made up of several pieces;
a manufacturing tool, the geometry of which corresponds to the shape of the part BA to be protected against ice, is used, the manufacturing tool optionally being covered with a non-stick coating;
The reinforcing layer 5 is a textile reinforcement adhered by the addition of chemical products, of primary types in aqueous solution or comprising a solvent, by dry process, by powder deposition, by plasma, etc. ;
The outer layer 6 is deposited on the manufacturing tool, in particular manually or automatically;
The reinforcing layer 5, in particular optionally previously scalloped to be able to fit the manufacturing tool, is deposited on the outer layer 6;
The intermediate layer 4 is deposited on the reinforcement layer 5;
The heating layer 3 is deposited on the intermediate layer 4;
The electrical power connections are made, for example, by soldering;

The contact layer 2 is deposited on the heating layer 3;
A vacuum pocket is then made on the multilayer structure thus formed;
The whole is then vulcanized under vacuum in an autoclave oven;
At the end of vulcanization, a demolding step is carried out and various finishing operations, such as in particular a trimming operation, are carried out;
A layer of paint 7 can be added on the outer layer 6;
The ice protection mat 1 thus formed can subsequently be assembled to the part BA to be protected, for example by a cold bonding method.

The ice protection mat 1 thus produced can be added by gluing the contact layer 2 to the outer surface 11 of the part BA to be protected.

Other assembly techniques other than bonding are also possible, such as, for example, co-curing or co-vulcanization, particularly when the part BA to be protected is made of a composite material.

An adhesion primer may be added before depositing the glue on the part BA to be protected from ice and/or on the contact layer 2, at least one of the surfaces of the part BA or of the contact layer 2 intended to be placed on top of each other being able to be subject to a surface preparation treatment, such as abrasion, deposition of primer or any other dry or plasma adhesion treatment.

In the foregoing description, the part BA to be protected was, for the purposes of the example, a leading edge of an aircraft wing.

The ice protection mat 1 according to the invention can be attached to any other aircraft part requiring protection against ice, such as engine air intakes, turbomachine rectifiers, airplane or helicopter propeller blades, propeller engine cones, protective radomes, etc.

It should be noted that the multilayer structure proposed for the ice protection mat 1 is particularly flexible and conformable. It is able to adapt to different three-dimensional shapes which can be considered for parts BA.

In the case of a de-icing type operating mode, the heating layer 3 is advantageously supplied in cycles so as to allow detachment of ice which would have formed on the outer surface of the ice protection mat 1.

For example, in the case of a de-icing type operating mode, the heating layer 3 is supplied with electricity for a determined period at regular intervals.

Typically, in the case of a de-icing type operating mode, an electrical power applied to the heating layer 3 is comprised between 1 W/cm² and 3 W/cm², in particular comprised between 2 and 3 W/cm².

In the case of an anti-icing type operating mode, the heating layer 3 is supplied continuously, so as to permanently prevent any formation of ice on the part BA to be protected from ice.

Typically, in the case of an anti-icing type operating mode, an electrical power applied to the heating layer 3 can reach up to 5 W/cm².

In the detailed presentation of the invention given above, the terms used should not be considered as limiting the invention to the embodiments set forth in the description just set forth, but should be interpreted to include all equivalents the prediction of which is within the reach of the person skilled in the art by applying their general knowledge to the implementation of the teaching just disclosed to them.

1. An ice protection mat for at least one part, the ice protection mat comprising:
at least one heating layer; and
at least one reinforcing layer,
wherein said at least one heating layer incorporates at least one heating resistor,
wherein said at least one reinforcing layer is positioned between the at least one heating layer and an external environment, and
wherein the at least one reinforcing layer has a thermal conductivity perpendicular to a general plane of extension of the at least one reinforcing layer that is greater than 0.6 W/mK at ambient temperature.

2. The ice protection mat according to claim 1, wherein the at least one reinforcing layer includes a network of woven, non-woven and/or mesh fibers or threads having a longitudinal thermal conductivity greater than 0.6 W/mK at ambient temperature.

3. The ice protection mat according to claim 2, wherein the at least one reinforcing layer includes the network of mesh fibers or threads, and the mesh fibers or threads of the at least one reinforcing layer have a longitudinal thermal conductivity greater than 50 W/mK at ambient temperature.

4. The ice protection mat according to claim 3, wherein the mesh fibers or threads have a longitudinal thermal conductivity greater than 120 W/mK at ambient temperature.

5. The ice protection mat according to claim 2, wherein the at least one reinforcing layer comprises carbon threads or fibers.

6. The ice protection mat according to claim 5, wherein the carbon threads or fibers are pitch threads or fibers.

7. The ice protection mat according to claim 2, wherein the at least one reinforcing layer comprises threads or fibers with a polyacrylonitrile (PAN) type precursor.

8. The ice protection mat according to claim 2, wherein the at least one reinforcing layer comprises threads or fibers comprising glass fibers, basalt fibers, silica fibers or metal threads.

9. An assembly comprising:
at least one part, having an external surface
wherein the external surface is covered by an ice protection mat comprising at least one heating layer and at least one reinforcing layer, said at least one heating layer incorporating at least one heating resistor, and said at least one reinforcing layer being positioned between the at least one heating layer and an external environment, and
wherein the at least one reinforcing layer has a thermal conductivity perpendicular to a general plane of extension of the at least one reinforcing layer greater than 0.6 W/mK at ambient temperature.

10. The assembly according to claim 9, wherein the ice protection mat comprises a contact layer that is positioned between the part and the at least one heating layer and that is glued or co-vulcanized on the part.

11. The ice protection mat according to claim 1, wherein the at least one part is an aircraft part.

12. The ice protection mat according to claim 6, wherein the pitch threads or fibers comprise coal or petroleum pitch.

13. The assembly according to claim 9, wherein the at least one part is an aircraft part.
